(19) United States
(12) Patent Application Publication
(10) Pub. No.: US 2006/0156993 A1
(43) Pub. Date: Jul. 20, 2006

(54) Litter box enclosure

(76) Inventor: Glenn E. Wright, Indianapolis, IN (US)

Correspondence Address: PHILIP L BATEMAN, P O BOX 1105, DECATUR, IL, 62525, US

(21) Appl. No.: 11/333,874

(22) Filed: Jan. 17, 2006

Related U.S. Application Data
(60) Provisional application No. 60/645,525, filed on Jan. 19, 2005.

(51) Int. Cl. A01K 1/035

(52) U.S. Cl. 119/165

(57) ABSTRACT

A litter box enclosure incorporates an electric air pump attached or connected to the enclosure. The enclosure has a flap located in one wall to allow the cat to enter and exit. Malodorous air is continuously removed from the litter box enclosure as it is compressed by the air pump and moved under pressure through a small diameter hose to a remote location.

### CROSS-REFERENCE TO RELATED APPLICATION

This application claims the benefit of U.S. Provisional Application Ser. No. 60/645,525, Jan. 19, 2005.

### FIELD OF THE INVENTION

This invention relates to animal husbandry. More particularly, this invention relates to litter box enclosures for the domestic cat.

### BACKGROUND OF THE INVENTION

Man domesticated the cat thousands of years ago. The domesticated cat recently passed the dog as the most popular pet in the United States. One reason for the cat's popularity is its instinctive burying of its bodily wastes. This instinct enables cat owners to easily train their cats to use a litter box for urination and defecation. A litter box is a tray, pad, liner, or other container holding clay pellets, sand, sawdust, or the like. The litter is strained and replaced periodically.

The litter box must, of course, be kept in a location the cat can reach. It is usually placed within a laundry room, bathroom, or basement of a house. Although litter boxes are widely used, they are inherently malodorous because of the waste they contain. To reduce odors in the room, litter boxes are sometimes placed inside enclosures.

To vent the odors from inside the litter box enclosures, a variety of ventilation systems have been disclosed. For example, Ingebritsen, U.S. Pat. No. 3,487,814, Jan. 6, 1970, entitled “Portable Ventilated Pet Station” discloses a portable pet enclosure having a fan in a compartment located at the top of the enclosure to draw air through a deodorizing filter.

Gershman, U.S. Pat. No. 4,522,150, Jun. 11, 1985, entitled “Cat Litter Disposal Housing” discloses a litter box enclosure with a means for sifting litter. The enclosure has a fan attached that circulates and draws air through a deodorizing filter.

Miksitz, U.S. Pat. No. 5,044,325, Sep. 3, 1991, entitled “Ventilated Litter Box,” discloses an enclosure having a tray with a porous bottom. A duct runs from the tray to an exhaust fan. Air is pulled by the exhaust fan from the enclosure through the duct and exhausted at a remote location, either outdoors or through a deodorizing filter.

Compagnucci, U.S. Pat. No. 5,134,972, Aug. 4, 1992, entitled “Ventilated Pet Litter Box” discloses an enclosed litter box that contains a fan, in a fan housing, attached to the top of the litter box enclosure. A duct is connected from the fan housing through a wall. The fan moves air from the enclosed litter box enclosure through a wall to a remote outdoor location.

Roberts, U.S. Pat. No. 5,140,948, Aug. 25, 1992, entitled “Vented Cat Litter Box Apparatus” discloses an enclosure having a fan located in a duct leading out of the enclosure. The fan is operated by a switch that activates via movement of the cat through the entry/exit door of the litter box enclosure. The fan moves air from the litter box enclosure to a remote outdoor location.

Kiera, U.S. Pat. No. 5,655,478, issued Aug. 12, 1997, entitled “Ventilation System Adapted For Use With Litter Boxes” discloses an adaptor that attaches to the top of the litter box enclosure. The adapter includes a fan to which a duct system is attached to move air from the litter box enclosure through a wall to a remote outdoor location.

Additional litter box enclosures are disclosed in Mimms et al., U.S. Pat. No. 5,315,964, May 31, 1994, entitled “Portable Cat Litter Box With Electronically Powered Ventilation”; Kovacs, U.S. Pat. No. 5,564,364, Oct. 15, 1996, entitled “Pet Litter Box With Automatic Exhaust System”; Simmons, U.S. Pat. No. 5,738,040, Apr. 14, 1998, entitled “Ventilated Cat Litter Box”; and Fields, U.S. Pat. No. 6,176,201, Jan. 23, 2001, entitled “Ventilated Cat Litter Box.” All these litter box enclosures incorporate a fan to move air from the litter box enclosure to a remote outdoor location.

The ventilation systems used in these enclosures to move air to a remote location require the use of large diameter ducting. This is the result of using a fan as a means of ventilation. This has been a significant disadvantage because the size of the ducting limits the locations where the litter box enclosures can be placed and requires significant modifications of an exterior wall or window if the air is to be exhausted to the outside environment. Accordingly, there is a demand for a ventilated litter box enclosure that does not require the use of large diameter ducting. More particularly, there is a demand for a ventilated litter box enclosure that provides greater flexibility in its placement and minimal modifications to an exterior wall or window if it is to be exhausted to the outside.

### SUMMARY OF THE INVENTION

The general object of this invention is to provide an improved litter box enclosure. A more particular object is to provide a litter box enclosure that provides greater flexibility in its placement and minimal modifications to an exterior wall or window if it is to be exhausted to the outside.

I have invented an improved litter box enclosure for holding a container of cat litter. The enclosure comprises a top and at least one wall to define an interior. The wall has an opening to allow for entry and exit of a cat. The opening has a covering that restricts, but does completely inhibit the movement of air into the enclosure. The enclosure further comprises an air pump with an inlet that communicates with the interior of the enclosure and with an outlet that communicates with a remote location. When the air pump is operated, ambient air is drawn through the opening into the interior and is then compressed and released at the remote location.

The litter box enclosure provides a new and improved means for eliminating odors from a litter box enclosure. The enclosure features a pump that allows malodorous air from the enclosure to be compressed and moved through a small diameter hose to be vented to the outdoors.

### BRIEF DESCRIPTION OF DRAWINGS

FIG. 1 is a perspective view of a preferred embodiment of the litter box enclosure the invention.

FIG. 2 is a perspective view thereof with the bottom section separated from the top section.

FIG. 3 is a side elevation view thereof.

FIG. 4 is a cross sectional side elevation view thereof showing air flow.

FIG. 5 is a side elevation view of a second embodiment of the litter box enclosure of the invention.

FIG. 6 is a side elevation view of a third embodiment of the litter box enclosure of the invention.

### DETAILED DESCRIPTION OF THE INVENTION

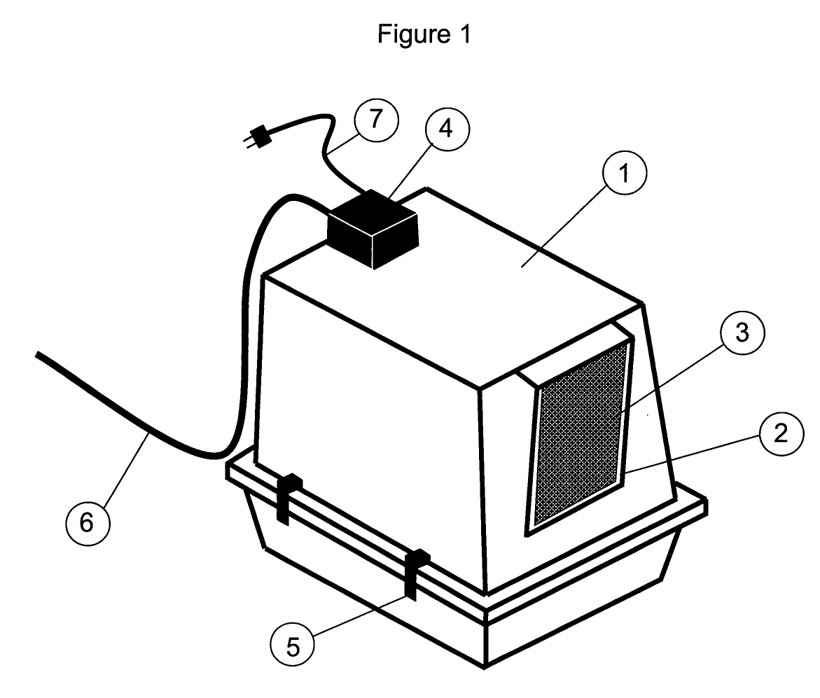

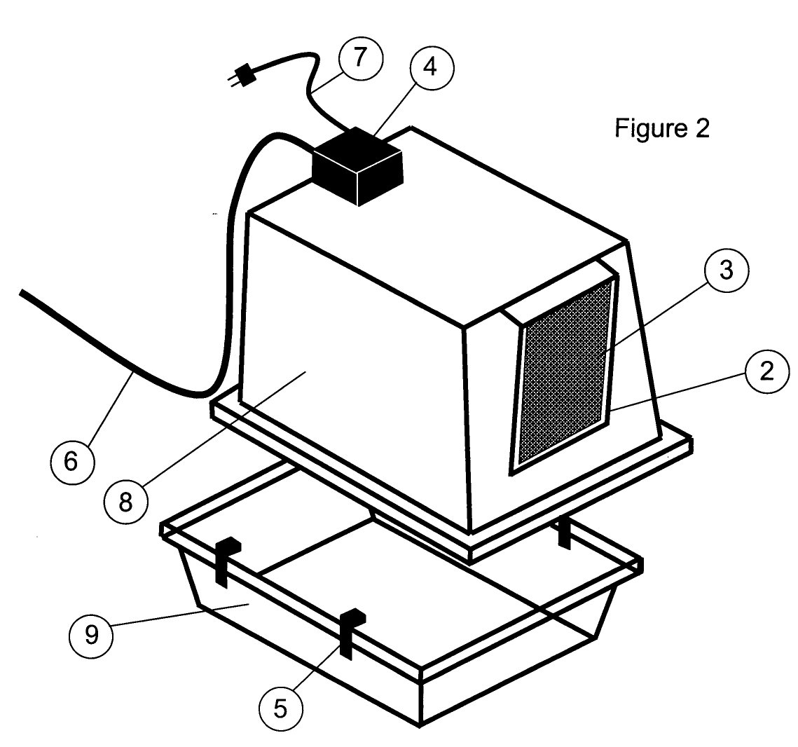

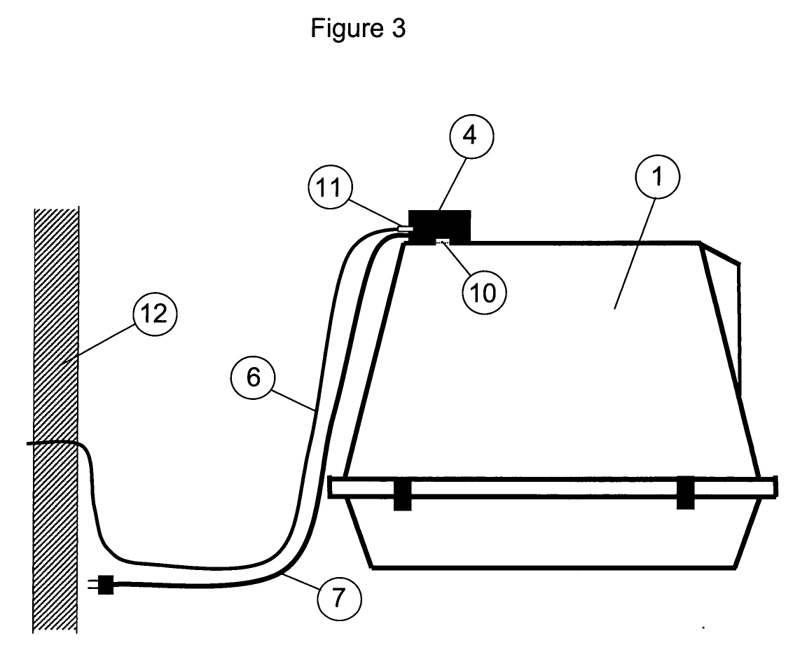

This invention is best understood by reference to the drawings. Referring to FIGS. 1 to 3, the preferred embodiment of the litter box enclosure 1 is rectangular in shape and contains a top, a bottom, and four walls connecting the top and bottom. Other shapes are suitable, such as square, triangular with three walls, cylindrical with a single wall, pyramidal with three walls and a top formed by the intersection of the three walls, and the like. A bottom is preferred but not required. An opening 2 of an appropriate size to allow ingress for the cat is located in one of the walls. A pivoting flap 3 is positioned within the opening and is of such a design that it can be easily pushed open from either direction and is not completely airtight. To allow entry by the human caretaker for the cat, the litter box enclosure preferably has an upper section 8 and bottom section 9. The bottom section is secured to the upper section by clips 5 or the like to ensure a tight fit. The enclosure is preferably made of plastic although other materials can be used. A litter box containing litter (not shown and not part of the enclosure) is placed in the bottom section of the enclosure.

An air pump 4 is attached to the top of the litter box with the air pump's intake stem 10 communicating with the interior of the litter box enclosure. The air pump compresses air and moves it under pressure through a small diameter hose. The most common types of air pumps use a moving diaphragm or cylinder to compress the air. A suitable air pump is a single outlet RENA Model 300 aquarium air pump manufactured by Rena France. This air pump employs a moving diaphragm and is able to pump up to 200 liters of air per hour at a maximum pressure of 300 mb. The choice of the air pump is dependent on the size of the enclosure. As the size of the enclosure increases, the capacity of the air pump increases correspondingly.

One end of a small diameter flexible hose 6 is attached to the outlet stem 11 on the air pump. The other end of the small diameter hose is passed through an exterior wall 12 to the outdoors. The small diameter hose can alternately be passed through an exterior window. As another alternative, the outlet of the hose can be vented to an interior space, such as a garage or a crawl space, if odor in such a space is not a concern or if the air is filtered to reduce odor. The diameter of the outlet hose is generally less than one inch and is preferably less than one-half inch.

When the air pump is connected to a power source via the air pump's power cord 7, the pump begins drawing malodorous air from the interior of the enclosure through the pump's intake stem. The malodorous air is compressed by the pump and exits the pump under pressure through the pump's outlet stem and enters the small diameter hose. The malodorous air travels through the small diameter hose to the outdoors.

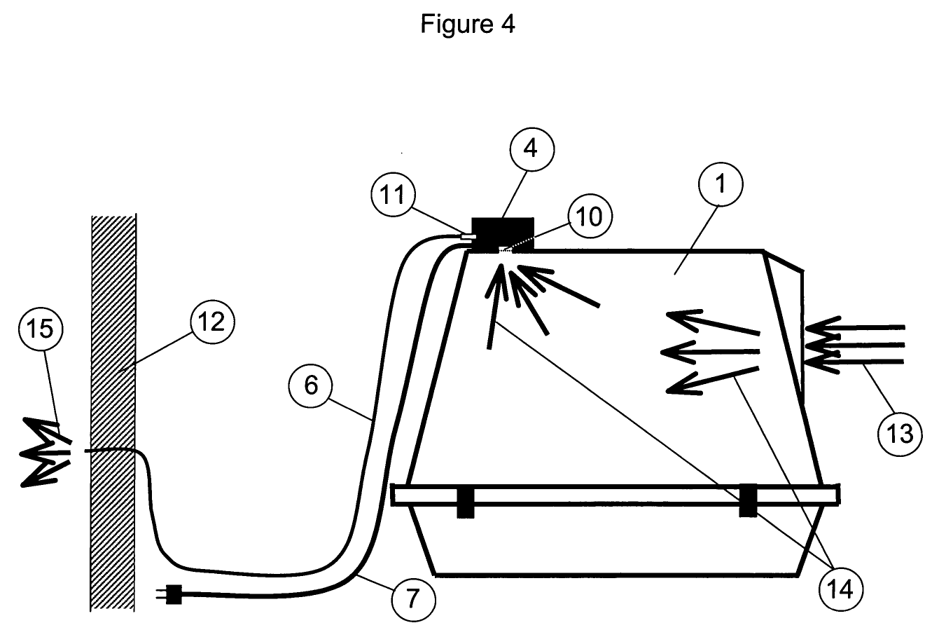

Referring now to FIG. 4, this movement of air sets up an air pattern in which air from the environment (represented by arrows 13) surrounding the enclosure is pulled into the enclosure through the opening covered by the flap. The air then moves through the enclosure (represented by arrows 14) and into the pump where it is compressed and travels under pressure through the small diameter hose and exits to the outdoors (represented by arrows 15).

The use of a pump to compress the malodorous air allows a small diameter hose to be used to move the malodorous air under pressure to a remote location outdoors. This eliminates the need for the bulky large diameter duct work and accompanying modifications to exterior walls or windows that must be used with systems designed using fans as the means of ventilation. Because the malodorous air is pumped under pressure, the maximum length of tubing that may be used and the number of bends allowed are also significantly greater than with the fan based systems.

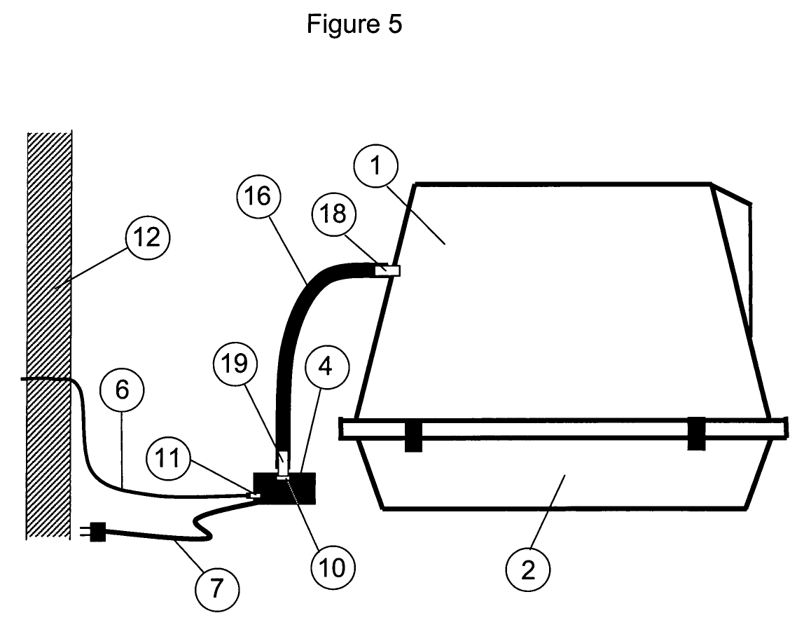

Referring now to FIG. 5, a second embodiment of the litter box differs from the first embodiment in the location of the air pump. In the second embodiment, the air pump is mounted away from the enclosure and communicates with the interior of the enclosure via a large diameter hose 16 connected between fitting 18 of the enclosure and intake fitting 19 of the air pump. This embodiment reduces the noise level inside the litter box enclosure.

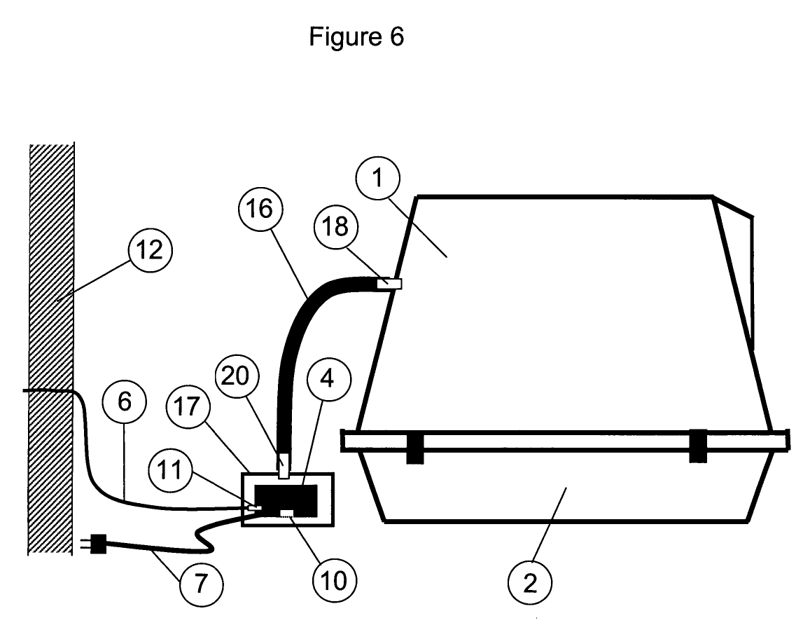

Referring now to FIG. 6, a third embodiment of the litter box enclosure reduces the noise level from the air pump inside the enclosure and in the environment surrounding the enclosure. This enclosure incorporates the use of a pump contained within an airtight box or other enclosure 17 connected to the litter box enclosure via a large diameter hose. One end of a large diameter hose is connected to the air intake stem 20 on the airtight box and the other end of the large diameter hose is connected to the air outlet stem on the litter box enclosure. The diameter of the hose is such that air can easily pass between the litter box enclosure and the airtight box. The diameter of the large hose is generally about one to three inches and is preferably about one and one-half to two inches. The small diameter hose 6 passes through the side of the airtight box through a hole slightly smaller than the diameter of the hose such that an airtight seal is made but the hose is not restricted to a point where air cannot flow easily under pressure. The power cord for the pump is also passed through the wall of the airtight box such that an airtight seal is made.

When the air pump of the third embodiment is turned on, malodorous air is drawn from the litter box enclosure through the litter box enclosure's outlet stem, through the large diameter hose, through the airtight box's intake stem, through the airtight box, through the air pump's intake stem, and into the pump where the malodorous air is compressed. The compressed malodorous air exits the air pump through the air pump's exit stem and moves under pressure through the small diameter hose, and through an exterior wall or window to the outdoors.

I claim:

1. A litter box enclosure for holding a container of cat litter, the enclosure comprising a top and at least one wall to define an interior, the wall having an opening to allow for entry and exit of a cat, the opening having a covering that restricts but does completely inhibit the movement of air into the enclosure, the enclosure further comprising an air pump with an inlet that communicates with the interior of the enclosure and with an outlet that communicates with a remote location, such that ambient air is drawn through the opening into the interior and is then compressed and released at the remote location.

2. The litter box enclosure of claim 1 wherein the air pump outlet communicates with the remote location through a tube having a diameter of less than about one inch.

3. The litter box enclosure of claim 2 additionally comprising a bottom and wherein the wall of the enclosure connects the top and the bottom.

4. The litter box enclosure of claim 3 wherein the covering of the opening comprises a pivoting flap.

5. The litter box enclosure of claim 4 wherein the air pump comprises a moving diaphragm.

6. The litter box enclosure of claim 4 wherein the air pump is located within an airtight enclosure to reduce noise.

7. The litter box enclosure of claim 4 wherein the air pump is mounted on the top of the enclosure.

8. The litter box enclosure of claim 4 additionally comprising an odor reducing filter in the outlet of the air pump.
